(19) United States
(12) Patent Application Publication
(10) Pub. No.: US 2017/0090866 A1
(43) Pub. Date: Mar. 30, 2017

(54) UNIVERSAL SENSOR AND/OR SENSOR CLUSTER TO PROVIDE A DETECTION PATTERN

(71) Applicants: Robert L. Vaughn, Portland, OR (US); Roy L. Doyal, Albuquerque, NM (US)

(72) Inventors: Robert L. Vaughn, Portland, OR (US); Roy L. Doyal, Albuquerque, NM (US)

(21) Appl. No.: 14/865,894

(22) Filed: Sep. 25, 2015

(51) Int. Cl. G06F 7/02

(52) U.S. Cl. CPC G06F 7/02

(57) ABSTRACT

Systems, apparatuses, and/or methods may provide for cooperative assembly of a universal sensor with one or more other universal sensors into a general-purpose sensor cluster deployable in a dynamically configurable arrangement. The universal sensor may capture data corresponding to one or more characteristics in a deployment environment encountered by the universal sensor. The universal sensor may also provide the data corresponding to at least one of the characteristics in the deployment environment encountered by the universal sensor. A baseline detection pattern may be established for the general-purpose sensor cluster based on data provided by each universal sensor of the general-purpose sensor cluster. Also, a change may be detected in the baseline detection pattern to address an anomalous condition. A proxy may mediate pairing between two or more universal sensor and/or between a universal sensor and a repository.

### TECHNICAL FIELD

Embodiments generally relate to a universal sensor. More particularly, embodiments involve a universal sensor that may assemble into a sensor cluster to provide data for a detection pattern.

### BACKGROUND

Specific-purpose sensors may be integrated into a part of an instrument to provide sensor data. For example, a brake sensor may include specific-purpose wiring and/or logic to detect friction of a brake system in a vehicle. Thus, the specific-purpose sensor may need to be replaced when a part of an instrument having the specific-purpose sensor fails. In addition, the specific-purpose sensor cannot be used for another purpose when the part fails. Moreover, a manufacturer may fix a location of the specific-purpose sensor. Accordingly, cost and/or complexity may be relatively large when utilizing specific-purpose sensors in a deployment environment.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a system to provide a detection pattern according to an embodiment;

FIG. 2 is a flowchart of an example of a method to generate data in a sensor cluster according to an embodiment;

FIG. 3 is a flowchart of an example of a method to mediate pairing involving a sensor cluster according to an embodiment;

FIG. 4 is a flowchart of an example of a method to process data from a sensor cluster according to an embodiment; and

FIG. 5 is a block diagram of an example of a computing system according to an embodiment.

### DESCRIPTION OF EMBODIMENTS

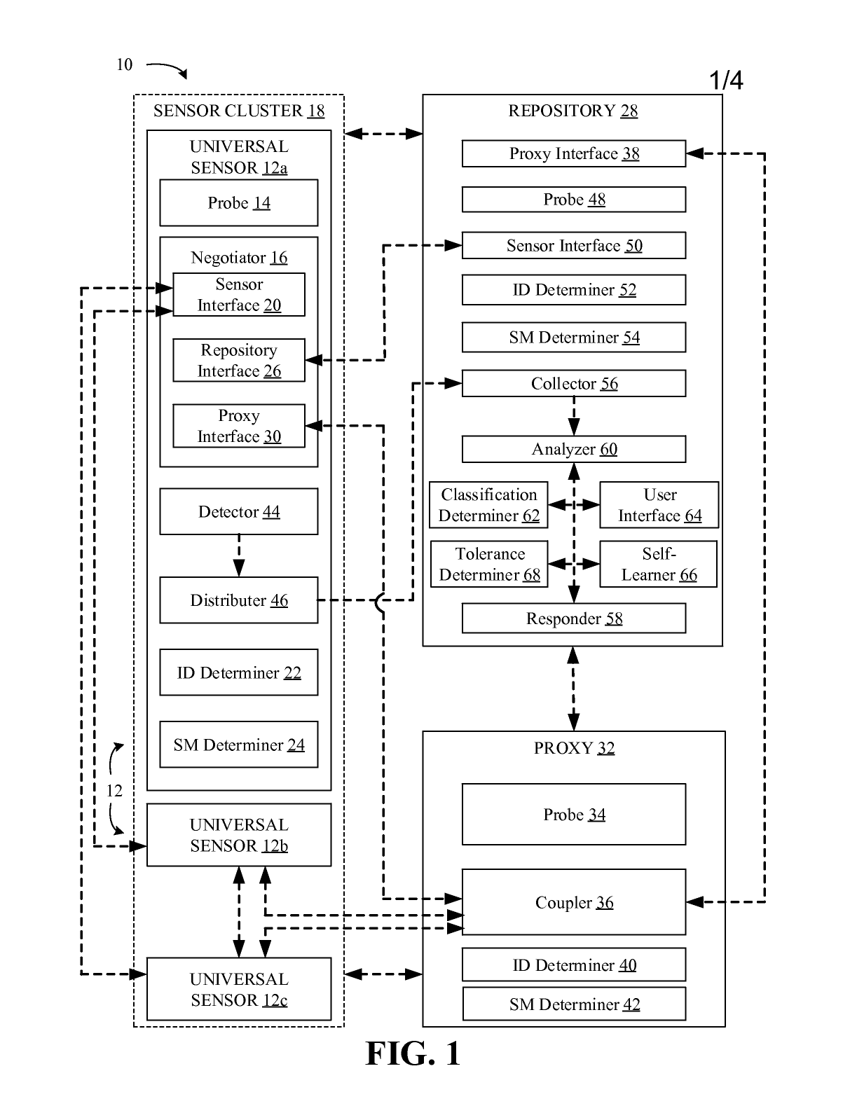

Turning now to FIG. 1, a system 10 is shown including universal sensors 12 (12a-12c) that may be suitable and/or adaptable for any deployment environment. Any or all of the universal sensors 12 may include an attachment member that provides ad-hoc connection with various objects in a deployment environment such as, for example, an automobile part (e.g., a brake, a tire, a lug nut, a bow, a wing, a propeller, etc.), a fluidic part (e.g., a valve, a conduit, a mixer, a compressor, etc.), a building part (e.g., a wall, a ceiling, a floor, etc.), and so forth. The attachment member may include a connector that secures the universal sensors 12 to an object such as an adhesive connector, a thread connector, a weld connector, a clip connector, a snap connector, a rail connector, a bolt connector, a screw connector, and so forth. Thus, any or all of the universal sensors 12 may be mechanically releasable sensors (e.g., moveable without damage, easily re-purposed, etc.) for ad-hoc deployment and/or retrofitting in any deployment environment.

Additionally, any or all of the universal sensors 12 may include general-purpose sensing capacities for ad-hoc deployment and/or retrofitting in any deployment environment. For example, any or all of the universal sensors 12 may include a general-purpose pressure sensing capability, temperature sensing capability, vibration sensing capability, acceleration sensing capability, velocity sensing capability, rotation sensing capability, flow sensing capability, analyte sensing capability, and so forth. Notably, the universal sensors 12 may not require specific-purpose hardware and/or software for a specific purpose as may be needed for specific-purpose sensors. Thus, any or all of the universal sensors 12 may include a multi-functional Internet of Things (IoT) sensor.

The illustrated universal sensor 12a includes a probe 14 to identify universal sensors proximately located to the universal sensor 12a. In one example, the universal sensors 12a-12c may be brought within a pre-determined proximity, based for example on a communication protocol spacing requirement, to allow the probe 14 to discover the universal sensors 12b, 12c. The probe 14 may identify, for example, an electromagnetic signal (e.g. an RF signal) from any or all of the universal sensors 12b, 12c. The probe 14 may also identify, for example, a notification signal from any or all of the universal sensors 12b, 12c indicating sensor capability, sensor availability, sensor presence, cluster presence, sensor compatibility, and so forth. The probe 14 may also provide a signal to allow any or all of the universal sensors 12b, 12c to discover the universal sensor 12a.

The sensor 12a further includes a negotiator 16 to cooperatively assemble the universal sensor 12a with the universal sensors 12b, 12c into a sensor cluster 18, which may be deployed in a dynamically configurable arrangement. For example, any or all of the universal sensors 12a-12c may be arranged in real-time before or after pairing into the sensor cluster 18. In one example, a user (e.g., an end-user, a distributer, a manufacturer, etc.) may remove the universal sensors 12a-12c from packaging and physically bring the universal sensors 12a-12c together within a pre-determined proximity for self-assembly into the sensor cluster 18. The user may also position the sensor cluster 18, in real-time, in any desired physical arrangement.

Accordingly, the illustrated negotiator 16 includes a sensor interface 20 to pair the universal sensor 12a with the universal sensors 12b, 12c and allow cooperative assembly into the sensor cluster 18. The sensor interface 20 may include wireless communication functionality such as, for example, WiFi (Wireless Fidelity, e.g., Institute of Electrical and Electronics Engineers/IEEE 802.11-2007, Wireless Local Area Network/LAN Medium Access Control (MAC) and Physical Layer (PHY) Specifications), Bluetooth (e.g., Institute of Electrical and Electronics Engineers/IEEE 802.15.1-2005, Wireless Personal Area Networks), NFC (Near Field Communication, ECMA-340, ISO/IEC 18092), and other radio frequency (RF) purposes. Thus, for example, the user may bring the universal sensors 12a-12c sufficiently close to each other (e.g., 10 cm or less) to allow pairing between the universal sensors 12a-12c via NFC.

The universal sensors 12a-12c may also exchange information before, during, and/or after pairing. In this regard, the illustrated universal sensor 12a includes an identification (ID) determiner 22 to determine a sensor ID value corresponding to the universal sensor 12a and/or to determine a cluster ID value corresponding to the sensor cluster 18. In one example, the ID determiner 22 may identify a trusted authority (e.g., certificate authority, etc.) to determine the sensor ID value for the universal sensor 12a and/or the cluster ID value for the sensor cluster 18. In another example, ID information may be received from the trusted authority via a mediator device (e.g., a proxy).

In a further example, the ID determiner 22 may choose a random seed number to be exchanged, for example via the sensor interface 20, with the universal sensors 12b, 12c. In this case, a universal sensor having a pre-determined value (e.g., highest value, lowest value, etc.) may assign itself a sensor ID value and/or a cluster ID value (e.g., cluster ID_node ID=cluster_1_node_1). The ID values that are assigned may themselves be based on a random number. Notably, the utilization of random numbers may minimize collisions caused by an inadvertent assignment of the same ID values.

The remaining universal sensors may then continue to communicate until all universal sensors have an assigned sensor ID value. In this regard, an initial universal sensor having an assigned sensor ID value may share the cluster ID value with the remaining universal sensors that continue to negotiate for a next (e.g., unused) sensor ID value. The initial universal sensor may also assign sensor ID values. Subsequently, a new universal sensor wishing to participate as a member in the sensor cluster 18 may identify any or all of the sensors 12a-12c, the sensor cluster 18, a master sensor, a mediator, a trusted authority, etc., for a next sensor ID value and/or the cluster ID value.

The universal sensor 12a further includes a security message (SM) determiner 24 to determine a security key corresponding to the universal sensor 12a and/or the sensor cluster 18. The universal sensors 12a-12c may utilize the same public/private key pair for the sensor cluster 18, and/or may have unique public/private key pairs. In one example, the SM determiner 24 may identify a trusted authority (e.g., certificate authority, etc.) to determine a public key and/or a private key for the universal sensor 12a and/or the sensor cluster 18. In another example, security information may be received from the trusted authority via a mediator device. In a further example, the SM determiner 24 may determine the public key and/or the private key using a random seed value. In addition, the public key and/or the private key may be exchanged, for example via the sensor interface 20, with the universal sensors 12b, 12c. Thus, any or all of the universal sensors 12a-12c may individually generate, assign, and/or exchange ID information and security information such as ID values, keys, and so forth.

The negotiator 16 further includes a repository interface 26 to pair the universal sensor 12a with a repository 28. As discussed below, the repository 28 may establish a baseline detection pattern for the sensor cluster 18, based on data from each universal sensor of the sensor cluster 18, which represents a normal condition such as a condition exhibiting typical values for a characteristic in a particular environment. The repository 28 may also detect a change in the baseline signature pattern to determine and/or to address an anomalous condition, which may reference a deviation from the normal condition (e.g., a change in a typical value, etc.).

The negotiator 16 further includes a proxy interface 30 to pair the universal sensor 12a with a proxy 32 that is to mediate pairing involving the sensor cluster 18. The illustrated proxy 32 includes a probe 34 to identify any or all of the universal sensors 12a-12c, the sensor cluster 18, and/or the repository 28, which may be proximately located to the proxy 32. Thus, the proxy 32 may initiate pairing and/or may respond to a pairing request involving the sensor cluster 18 and/or the repository 28.

The proxy 32 includes a coupler 36 to mediate cooperative assembly of the universal sensors 12a-12c into the sensor cluster 18. The coupler 36 may, for example, communicate with the proxy interface 30 of the sensor 12a to pair the proxy 30 with the sensor 12a, communicate with the universal sensors 12b, 12c to pair the proxy 30 with the universal sensor 12b, 12c, and mediate pairing between the universal sensors 12a-12c. The coupler 26 may, for example, notify any or all of the universal sensors 12a-12c of proximity to one another, notify any or all of the universal sensors 12a-12c of pairing via the proxy 32, notify any or all of the universal sensors 12a-12c of a pre-existing sensor cluster, determine and/or notify any or all of the universal sensors 12a-12c of a master sensor and/or a trusted authority, determine and/or exchange ID information, determine and/or exchange security information, and so forth.

The coupler 36 may also communicate with a proxy interface 38 of the repository 28 to pair the proxy 30 with the repository 28 and mediate pairing of the sensor cluster 18 with the repository 28. The coupler 36 may, for example, notify any or all of the universal sensors 12a-12c and the repository 28 of proximity to one another, notify any or all of the universal sensors 12a-12c and the repository 28 of pairing via the proxy 32, notify the repository 28 of a pre-existing sensor cluster, notify the repository 28 of a master sensor and/or a trusted authority, determine and/or exchange ID information, determine and/or exchange security information, and so forth.

In one example, the proxy 32 may utilize NFC to identify any or all of the sensors 12a-12c and/or the repository 28, to pair any or all of the universal sensor 12a-12c and/or the repository 28, to exchange ID information and/or security information with any or all of the universal sensors 12a-12c and/or the repository 28, and so forth. In this regard, NFC may minimize security threats by requiring physical or near physical contact with the members of sensor cluster 18 and/or the repository 28. Moreover, the illustrated proxy 32 includes an ID determiner 40 and an SM determiner 42 that may function similar to the ID determiner 22 and the SM determiner 24, discussed above. Thus, the proxy 32 may determine, assign, and/or exchange sensor ID values, cluster ID values, keys, and so forth.

The proxy 32 may include a computing platform such as a desktop computer, notebook computer, tablet computer, convertible tablet, personal digital assistant (PDA), mobile Internet device (MID), media player, smart phone, smart televisions (TVs), a radio, a wearable device, a game console, and so forth. The proxy 32 may include communication functionality for a wide variety of purposes such as, for example, cellular telephone (e.g., Wideband Code Division Multiple Access/W-CDMA (Universal Mobile Telecommunications System/UMTS), CDMA2000 (IS-856/IS-2000), etc.), WiFi (Wireless Fidelity, e.g., Institute of Electrical and Electronics Engineers/IEEE 802.11-2007, Wireless Local Area Network/LAN Medium Access Control (MAC) and Physical Layer (PHY) Specifications), 4G LTE (Fourth Generation Long Term Evolution), Bluetooth (e.g., Institute of Electrical and Electronics Engineers/IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), NFC (Near Field Communication, ECMA-340, ISO/IEC 18092), and other radio frequency (RF) purposes.

When the sensor cluster 18 is established and/or deployed, a detector 44 of the universal sensor 12a may capture data corresponding to a characteristic in the deployment environment encountered by the universal sensor 12a. As discussed above, the characteristic of the deployment environment may include a temperature of a part of an automobile, a pressure of a part of a fluidic system, and so forth. Thus, the universal sensor 12a may include a temperature detector, a pressure detector, an accelerometer, a speedometer, a particulate detector, an optical detector, an electrical signal detector, and so forth. In addition, the data provided by the detector 44 may be filtered to provide less than all available data by, for example, powering down sensing functionality, preventing transmission and/or capture of data, and so forth. The sensor 12a may, however, provide all available data to maximize baseline pattern development, historical data development, and/or analytic functionality.

The sensor 12a further includes a distributer 46 to provide the data corresponding to the characteristic in the deployment environment encountered by the universal sensor 12a. The distributer 46 may provide a portion or all of the data for the sensor cluster 18 by, for example, aggregating data for the sensor cluster 18 via the sensor interface 20. The data provided by the distributer 46 may be encrypted via a key corresponding to the sensor 12a and/or the sensor cluster 18. The encrypted data may be provided by the distributer 44 to the repository 28 in machine-readable form that includes a field for payload (e.g., temperature data, pressure data, etc.) and a field for an ID value representing, for example, cluster 1_node_1_pressure_800_psi_temperature_180° C. (e.g., in a fluidic system). Notably, the data may lack specific-purpose data such as “valve pressure”, “conduit temperature”, and so forth.

The data provided by the distributer 46 may arrive at the repository 28 for evaluation. In this regard, the illustrated repository 28 includes a probe 48 to identify any or all of the universal sensors 12a-12c, the sensor cluster 18, the proxy 32, and so forth. The repository also includes a sensor interface 50 to pair the repository 28 with any or all of the universal sensors 12a-12c. As discussed above, the repository 28 further includes the proxy interface 38 to pair the repository 28 with the proxy 32, wherein the proxy 32 may mediate pairing of the repository 28 with the sensor cluster 18. Thus, for example, the repository 28 may utilize NFC to identify any or all of the sensors 12a-12c and/or the sensor cluster 18, to exchange ID information and/or security information, and so forth. In this regard, the repository 28 also includes an ID determiner 52 and an SM determiner 54 that may function similar to the ID determiners 22, 40 and the SM determiners 24, 42, discussed above.

The repository 28 may be an endpoint device such as a destination device for data, an aggregation device for data, and so forth. The repository 28 may also be a gateway device such as a gateway device between sensor clusters, a gateway device between computer networks, and so forth. In addition, the repository 28 may be a server device, a cloud-computing device such as a cloud-computing endpoint, gateway, server, and so forth. Thus, the repository 28 may include communication functionality for a wide variety of purposes such as, for example, cellular telephone (e.g., Wideband Code Division Multiple Access/W-CDMA (Universal Mobile Telecommunications System/UMTS), CDMA2000 (IS-856/IS-2000), etc.), WiFi (Wireless Fidelity, e.g., Institute of Electrical and Electronics Engineers/IEEE 802.11-2007, Wireless Local Area Network/LAN Medium Access Control (MAC) and Physical Layer (PHY) Specifications), 4G LTE (Fourth Generation Long Term Evolution), Bluetooth (e.g., Institute of Electrical and Electronics Engineers/IEEE 802.15.1-2005, Wireless Personal Area Networks), WiMax (e.g., IEEE 802.16-2004, LAN/MAN Broadband Wireless LANS), Global Positioning System (GPS), spread spectrum (e.g., 900 MHz), NFC (Near Field Communication, ECMA-340, ISO/IEC 18092), and other radio frequency (RF) purposes.

The repository 28 further includes a collector 56 to collect data provided by each universal sensor 12a-12c of the sensor cluster 18, individually, through a master sensor, through the proxy 32, and so forth. The collector 56 may store the data in memory, in storage, etc., which may be encrypted and subsequently decrypted to confirm integrity of the data before evaluation. The data may also be decrypted for display in human-readable form. When the data is corrupt, a security action may be implemented by a responder 58 including, for example, blocking information from a universal sensor, causing deletion of a universal sensor from the sensor cluster 12a, notifying a user, etc.

The repository 28 further includes an analyzer 60 to evaluate the data from the universal sensors 12a-12c and establish a baseline detection pattern for the sensor cluster 18 based on the data. In one example involving an automobile, the universal sensors 12a-12c may be attached ad-hoc to different lug nuts of a wheel. In this case, the analyzer 60 establishes a baseline detection pattern for the sensor cluster 18 that may include a range of detection values provided by the universal sensors 12a-12c. The values provided by the universal sensors 12a-12c may be typical values corresponding to characteristics exhibited at the wheel such as, for example, typical acceleration values, typical velocity values, typical GPS values, typical vibration values, typical rotation values, and so forth.

The universal sensors 12a-12c may provide the same type of value when the universal sensors 12a-12c include the same general-purpose sensing capability and/or are responsible for providing data corresponding to the same characteristic. Thus, the analyzer 60 may evaluate data representing, for example, cluster_1_node_1_vibration_20 mm/s_cluster_1_node_2_vibration_21 mm/s_cluster_1_node_3_vibration_20 mm/s. In addition, the analyzer 60 may establish a baseline detection pattern such as cluster_1_vibration_20-21 mm/s based on the data. The universal sensors 12a-12c may also provide a different type of value when the sensors 12a-12c include different general-purpose sensing capabilities and/or are responsible for providing data corresponding to different characteristics. Thus, the analyzer 60 may evaluate data representing, for example, cluster_1_node_1_vibration_20 mm/s_cluster_1_node_2_rotation_840 rpm_cluster_1_node_3_velocity_60 mph. In addition, the analyzer 60 may establish a baseline detection pattern such as cluster_1_vibration_20 mm/s_rotation_840 rpm_veocity_60 mph based on the data.

The repository 28 further includes a classification determiner 62 to determine a label indicating a special-purpose relationship for the sensor cluster 18. In one example, a user interface 64 may accept user input that indicates a specific-purpose relationship when the sensor cluster 18 is paired with the repository 28. The user input may be stored to apply the label corresponding to the data when the data is received. Continuing with the example above, a user may utilize the user interface 64, accessible via an infotainment system of the automobile, to select and/or add a description for the sensor cluster 18. The label may then be applied to the data being analyzed at the analyzer 60, for example when cluster_1 is encountered, based on the user input such as “wheel”, “right wheel”, “right front wheel” and so forth. Thus, the analyzer 60 may evaluate the data in a context of a specific-purpose relationship such as wheel_cluster_1_vibration_20 mm/s_rotation_840 rpm_veocity_60 mph.

In another example, a self-learner 66 may utilize machine-learning processes to determine the specific-purpose relationship from the data itself. Continuing with the example above, the self-learner 66 may evaluate the data representing cluster_1_vibration_20 mm/s_rotation_840 rpm_veocity_60 mph and determine that the data includes one or more typical values for a wheel. The self-learner 66 may, for example, compare the data from the sensor cluster 18 to historical data from the sensor cluster 18, to pre-determined standard pattern data, and so forth. In this regard, a portion or all value types may be utilized in the comparison. Thus, the repository 28 may allow for classification of one or more sensor clusters in the same deployment environment to establish specific-purpose relationships and for evaluation of data received from the sensor clusters in a context of the relationships. In this regard, a user may select a label such as “car sensors” and the self-learner 66 may further classify (e.g., sub-classify) the data received into location relationships such as “wheel car sensor”, “right wheel car sensor”, “engine car sensor”, and so forth, which may be used to establish and/or evaluate baseline patterns, deviations, tolerance limits, recommendations, and so forth.

The repository 28 may also provide raw data from the sensor cluster 18, baseline detection patterns, and/or changes thereof to another entity, which may be at a higher level of a hierarchy (e.g., in a cloud computing environment, etc.), to allow the aggregation of information from discrete systems to be leveraged for refining local learning systems, to develop standards, and so forth. In one example, standard recommendations to be provided locally may be developed based on a classification of “engine car sensor” rather than “window car sensor”. In another example, standard communication protocols may be developed based on pairing statistics. In a further example, typical vibrations at particular speeds may be established to classify sensors, data, and/or sensor clusters, to determine anomalous conditions, and so forth.

Notably, the sensor cluster 18 may operate irrespective of knowledge of a specific-purpose relationship. For example, any or all of the universal sensors 12a-12c may not be required to know a specific purpose for which they are being utilized. Thus, the sensor cluster 18 and/or any or all of the universal sensors 12a-12c may be removed ad-hoc, added ad-hoc, and/or deployed dynamically in any desired configuration arrangement. In this regard, a part of an instrument having an integrated sensor may not need to be replaced when a sensor fails since it may be re-fitted with a universal sensor.

In addition, a part of an instrument that fails or that may fail can be exchanged with a replacement part that does not require an integrated sensor and that includes the same or broader sensing functionality. Moreover, a universal sensor may be re-purposed for use in another cluster when the part fails or when the universal sensor is no longer needed in the particular deployment environment. Also, a universal sensor may pair with a legacy sensor when, for example, the legacy sensor and/or the universal sensor includes logic to discover the other type of sensor, logic to pair with the other type of sensor, logic to share information, etc. Additionally, dynamic combinations of general-purpose universal sensors may allow for fine-grained and/or unique baseline detection patterns.

The analyzer 60 may also detect changes in the baseline detection pattern to determine and/or to address an anomalous condition. In this regard, a portion of or all value types may be utilized to detect changes in a baseline detection pattern. Continuing with the example above, the analyzer 60 may detect a change from data representing, for example, cluster_1_node_1_vibration_80 mm/s. The analyzer 60 determines, in this case, that the vibration is currently 80 mm/s, which is a change from the typical value of 20 mm/s in the baseline detection pattern. The analyzer 60 is now aware of an anomalous condition that may indicate a failure in the deployment environment, a likelihood of a failure in the deployment environment, an undesirable change, a need to investigate, etc. The analyzer 60 may, therefore, predict a failure and minimize downtime. In response, the responder 58 may implement an action such as notifying a user, taking a corrective action, providing a recommendation, scheduling a service, and so forth.

The repository 28 further includes a tolerance determiner 68 to determine a tolerance limit corresponding to the change in the baseline detection pattern. In one example, the user interface 64 may accept user input to select the tolerance limit. In another example, the self-learner 66 may utilize machine-learning processes to determine the tolerance limit by calculating an average value, a mean value, a standard deviation value, etc., based on, e.g., historical data from the sensor cluster 18. The tolerance determiner 68 may also select the tolerance limit from standard data (e.g., online data).

The tolerance determiner 68 may determine when the tolerance limit is met (e.g., exceeded) via, for example, a pairwise comparison between the data received at the repository 28 at different time intervals, between detection patterns generated at the repository 28 at different time intervals, and so forth. Thus, for example, a tolerance limit of vibration=60 mm/s may be met when the repository 28 receives the data representing, for example, cluster_1_node_1_vibration_80 mm/s. In this case, the responder 58 may notify the user when the tolerance limit is met, take corrective action to address an anomalous condition, provide a recommendation, schedule a service, etc.

One or more components of the system 10 may be combined into a single component or separated into individual components such as, for example, when the probe 14 and the sensor interface 20 are combined. In addition, one or more components of the system 10 may be omitted and/or bypassed such as, for example, omitting the proxy 32 when the sensor cluster 18 directly pairs with the repository 28. Additionally, the example flow denoted by dashed arrows may be modified. Moreover, particular components and/or communication flows discussed above with reference to the universal sensor 12a may also apply to the universal sensors 12b, 12c. Thus, particular components may be combined, omitted, bypassed, re-arranged, and/or flow in any order.

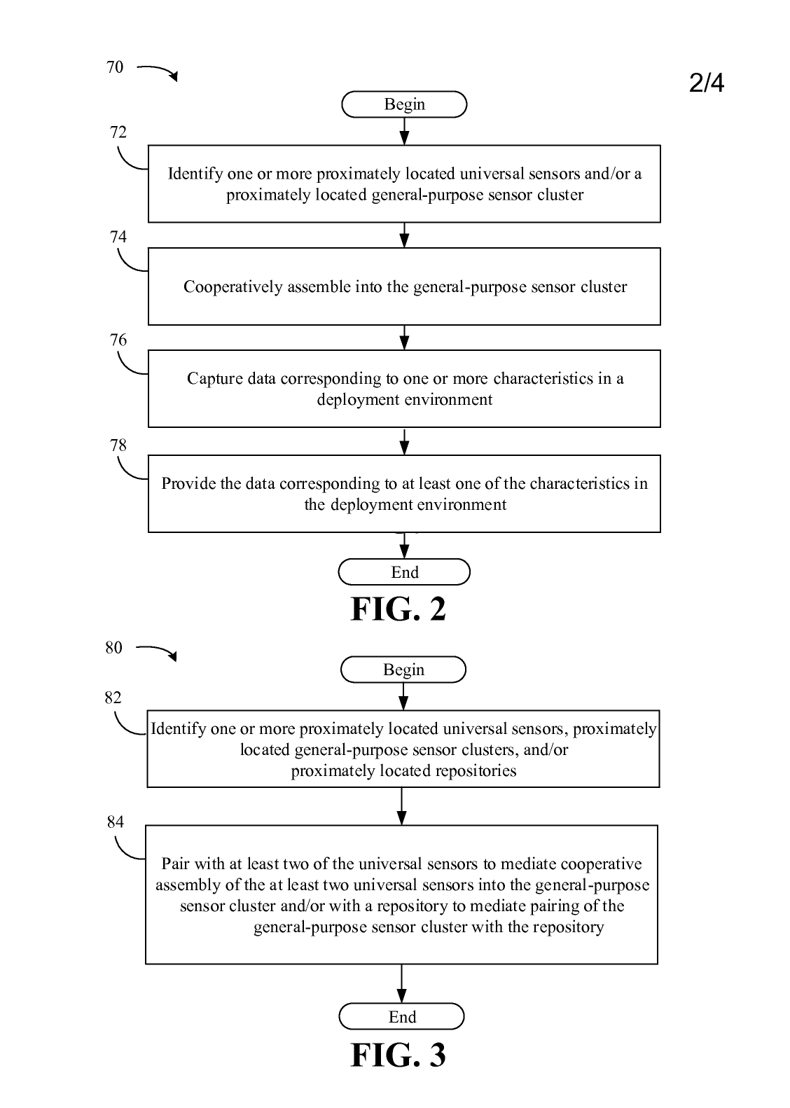

FIG. 2 shows a method 70 to generate data in a sensor cluster. The method 70 may be implemented by, for example, any or all of the universal sensors 12a-12c (FIG. 1), discussed above. The method 70 may be implemented as a module or related component in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 70 may be written in any combination of one or more programming languages, including an object oriented programming language such as JAVA, SMALLTALK, C++ or the like and conventional procedural programming languages, such as the “C” programming language or similar programming languages.

Illustrated processing block 72 provides for identifying a proximately located universal sensor and/or a proximately located general-purpose sensor cluster. For example, block 72 may discover one or more other universal sensors that are proximately located to the block 72. In addition, block 72 may discover one or more pre-existing sensor clusters that are proximately located to the block 72. Illustrated processing block 74 provides for cooperatively assembling into a general-purpose sensor cluster that may be deployable in a dynamically configurable arrangement. For example, block 74 may utilize NFC (e.g., device contact, proximity of 10 cm, etc.) to pair with any of the other universal sensors to cooperatively assemble into the general-purpose sensor cluster. Block 74 may also utilize NFC to pair with a proxy that may mediate cooperative assembly with any of the other universal sensors into the general-purpose sensor cluster.

Block 74 may further determine a sensor ID corresponding to a universal sensor and/or a cluster ID corresponding to the general-purpose sensor cluster. In addition, block 74 may provide the sensor ID and/or the cluster identification to a repository, a proxy, and/or any of the other universal sensors. Block 74 may further determine a security key corresponding to a universal sensor and/or the general-purpose sensor cluster. The security key may include a symmetric key pair, an asymmetric key pair, a certificate, and so forth. Block 74 may also provide the security key to a repository, a proxy, and/or any of the other universal sensors.

Illustrated processing block 76 provides for capturing data corresponding to a characteristic in a deployment environment. Block 76 may utilize, for example, a temperature detector, a pressure detector, an accelerometer, a speedometer, a particulate detector, an optical detector, an electrical signal detector, and so forth. In one example, block 76 may utilize a general-purpose IoT sensor to capture data corresponding to one or more characteristics in the deployment environment including pressure, temperature, vibration, acceleration, velocity, rotation, flow, analyte exposure, etc.

Illustrated processing block 78 provides for rendering the data corresponding to at least one of the characteristics in the deployment environment. Block 78 may provide a part or all of the data captured. In addition, block 78 may provide a part or all of the data for the general-purpose sensor cluster. In this regard, block 78 may pair with a repository that is to establish a baseline detection pattern for the general-purpose sensor cluster based on the data and/or that is to detect a change in the baseline detection pattern. Block 78 may also pair with a proxy that is to mediate pairing of the general-purpose sensor cluster with a repository. Pairing may include, for example, exchanging ID information, security information, and so forth.

FIG. 3 shows a method 80 to mediate pairing involving a sensor cluster. The method 80 may be implemented by, for example, the proxy 32 (FIG. 1), discussed above. The method 80 may be implemented as a module or related component in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 80 may be written in any combination of one or more programming languages, including an object oriented programming language such as JAVA, SMALLTALK, C++ or the like and conventional procedural programming languages, such as the “C” programming language or similar programming languages.

Illustrated processing block 82 provides for identifying one or more proximately located universal sensors, sensor clusters, and/or repositories. For example, block 82 may discover one or more other universal sensors that are proximately located to the block 82. Block 82 may also discover one or more pre-existing general-purpose sensor clusters that are proximately located to the block 82. In addition, block 82 may discover one or more repositories that are proximately located to the block 82.

Illustrated processing block 84 provides for pairing at least two of the universal sensors to mediate cooperative assembly of the at least two universal sensors into a general-purpose sensor cluster. For example, block 84 may utilize NFC to pair with the two universal sensors and mediate pairing of the two universal sensors, may initiate a pairing request and/or respond to the pairing request to transfer the pairing request between the two universal sensor, may exchange ID information and/or security information between the two universal sensors, and so forth. Thus, block 84 may allow two universal sensors to discover and/or to share information between each other.

Block 84 further provides for pairing a repository with the general-purpose sensor cluster, which may establish a baseline detection pattern for the general-purpose sensor cluster based on data provided by each universal sensor of the general-purpose sensor cluster and/or detect a change in the baseline detection pattern to address an anomalous condition. Thus, block 84 may allow one or more universal sensors and the repository to discover each other, to share information between each other, and so forth.

Block 84 may further determine a sensor ID corresponding to a universal sensor and/or a cluster ID corresponding to the general-purpose sensor cluster. In addition, block 84 may provide the sensor ID and/or the cluster ID to a universal sensor and/or a repository. Block 84 may further determine a security key corresponding to a universal sensor and/or the general-purpose sensor cluster. Moreover, block 84 may provide the security key to a universal sensor and/or to a repository.

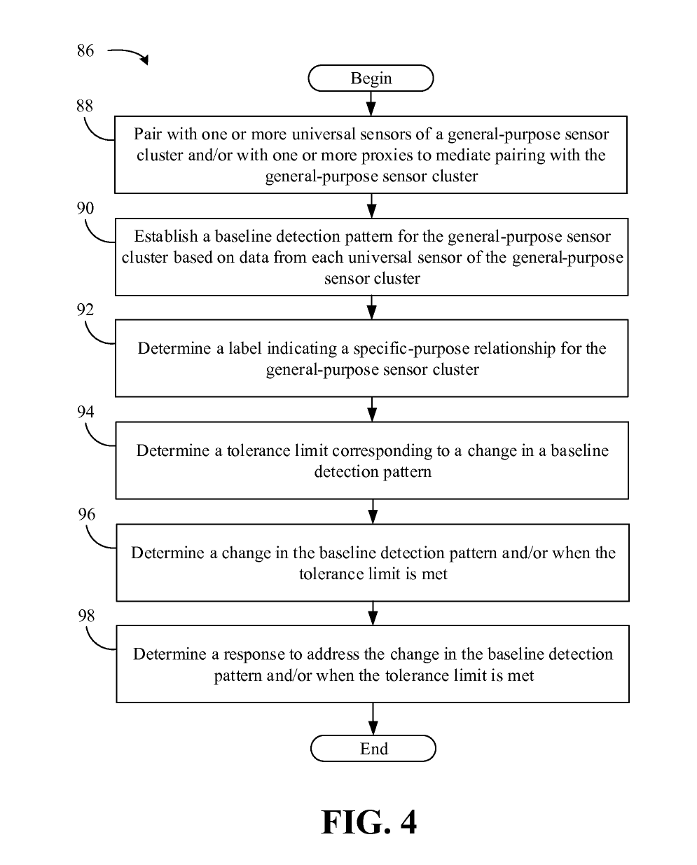

FIG. 4 shows a method 86 to process data from a sensor cluster. The method 86 may be implemented by, for example, the repository 28 (FIG. 1), discussed above. The method 86 may be implemented as a module or related component in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in the method 86 may be written in any combination of one or more programming languages, including an object oriented programming language such as JAVA, SMALLTALK, C++ or the like and conventional procedural programming languages, such as the “C” programming language or similar programming languages.

Illustrated processing block 88 provides for pairing with a universal sensor of a general-purpose sensor cluster and/or with a proxy that is to mediate pairing with the general-purpose sensor cluster. The block 88 may include, for example, identifying one or more proximately located universal sensors, sensor clusters, and/or proxies to accomplish the pairing process. In one example, block 88 may utilize NFC to pair with the general-purpose sensor cluster and/or the proxy, allow exchange of information with the general-purpose sensor cluster and/or the proxy, and so forth. Thus, block 88 may allow the block 88 and the general-purpose sensor cluster and/or the proxy to discover each other, to share information between each other, and so forth.

Block 88 may further determine a sensor ID corresponding to a universal sensor and/or a cluster ID corresponding to the general-purpose sensor cluster. In addition, block 88 may provide the sensor ID and/or the cluster ID to a universal sensor and/or a repository. Block 88 may further determine a security key corresponding to a universal sensor and/or the general-purpose sensor cluster, and/or may provide the security key to a universal sensor and/or a repository. Block 88 may further provide raw data from the general-purpose sensor cluster and/or a baseline detection pattern to another entity to maximize detection pattern development, historical data development, analytic functionality, and so forth.

Illustrated processing block 90 provides for establishing a baseline detection pattern for the general-purpose sensor cluster based on the data. For example, the baseline detection pattern may include one or more value types corresponding to one or more characteristics that are encountered in a deployment environment by one or more universal sensors. Illustrated processing block 92 provides for determining a label indicating a specific-purpose relationship for the general-purpose sensor cluster such as, for example, a location relationship (e.g., “wheel”), a function relationship (e.g., “valve temperature”), and so forth. Notably, a general-purpose sensor cluster may operate irrespective of knowledge of the specific-purpose relationship. Block 92 may also provide a user interface to allow for selection of the label via user input. In addition, block 92 may self-learn the label based on the data corresponding to a characteristic in a deployment environment, based on historical data for the sensor cluster, based on pre-existing standard data, and so forth.

Illustrated processing block 94 provides for determining a tolerance limit corresponding to a change in the baseline detection pattern and/or when the tolerance limit is met. In one example, block 94 may provide a user interface to allow for selection of the tolerance limit via user input. In another example, block 94 may self-learn and select the tolerance limit based on the data corresponding to a characteristic in a deployment environment, based on historical data for the sensor cluster, based on pre-existing standard data, and so forth.

Illustrated processing block 96 provides for detecting a change in the baseline detection pattern, for example to address an anomalous condition. Block 96 may, for example, execute a pairwise comparison between newly received data and previously received data from the general-purpose sensor cluster, between data received from the general-purpose sensor cluster and a baseline detection pattern for the general-purpose sensor cluster, between a newly established detection pattern for the general-purpose sensor cluster and a previously established detection pattern for the general-purpose sensor cluster, and so forth. Block 94 may also detect when a tolerance limit is met by, for example, executing a pairwise comparison between newly received data and the tolerance limit, a newly established detection pattern and the tolerance limit, and so forth.

Block 96 may also analyze one or more other values in response to a change in one value to validate the presence of an anomalous condition. For example, block 96 may evaluate data from an optical detector to determine whether there is a change in particulate concentration when a sudden rise in temperature is detected from a temperature detector. If so, block 96 may establish that there may be fire in a room based on the data from the sensor cluster, based on the specific-purpose relationship for the sensor cluster (e.g., “smoke detector”), based on historical data (e.g., data representative of a fire at that location), based on pre-existing standard data (e.g., data representative of a fire at a similar location), and so forth.

Illustrated processing block 98 provides for determining a response to address the change in the baseline detection pattern and/or when the tolerance limit is met. For example, block 98 may notify a user of the change and/or when the tolerance limit is met via a user interface, via an electronic message, via an alarm, and so forth. In addition, block 98 may provide recommendations regarding further investigation, resolutions that may be implemented to return to the baseline detection pattern, and so forth. Block 98 may also implement an action to correct the change. In one example, the change may indicate a failure in the deployment environment and/or a likelihood of a failure in a deployment environment. Thus, block 98 may schedule an appointment for further investigation, may re-direct resources to account for the change, may prevent utilization of a part of the deployment environment causing the change, and so forth.

While independent methods, blocks, and/or a particular order has been shown, it should be understood that one or more of the blocks of any of the methods 70, 80, 86 may be combined, omitted, bypassed, re-arranged, and/or flow in any order. For example, the methods 70, 80, 86 may be combined to accomplish one or more functions of the system 10 (FIG. 1), discussed above. In another example, the method 80 may be omitted and/or bypassed when a proxy is not involved.

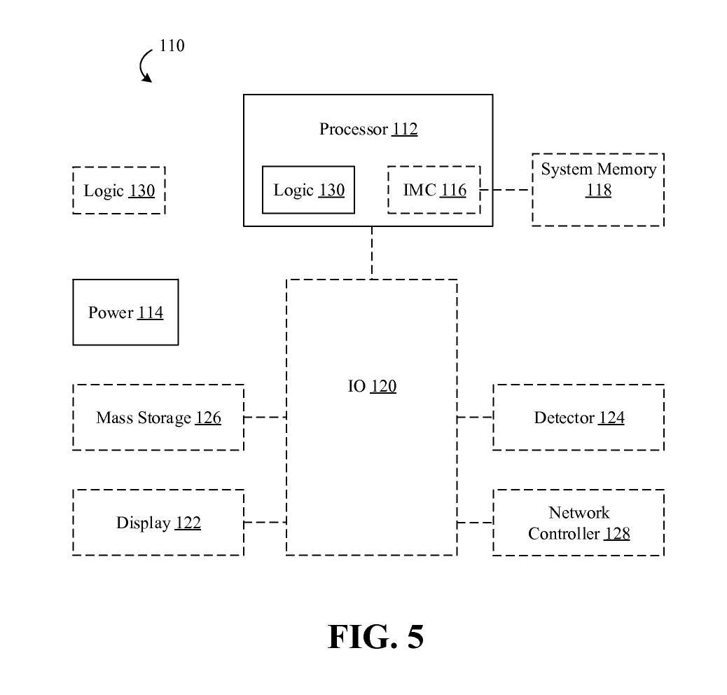

FIG. 5 shows a computing system 110 that may be part of a device having sensor functionality, computing functionality (e.g., PDA, notebook computer, tablet computer, convertible tablet, desktop computer, cloud server), communications functionality (e.g., wireless smart phone, radio), imaging functionality, media playing functionality (e.g., smart television/TV), wearable computer (e.g., headwear, clothing, jewelry, eyewear, etc.) or any combination thereof (e.g., MID). In the illustrated example, the system 110 includes a processor 112 and a power source 114, and may include an integrated memory controller (IMC) 116, system memory 118, an input output (10) module 120, a display 122, a detector 124 (e.g., color sensor, temperature sensor, accelerometer, IoT sensor, general-purpose sensor, etc.), mass storage 126 (e.g., optical disk, hard disk drive/HDD, flash memory), and a network controller 128.

The processor 112 may include a core region with one or several processor cores (not shown). The illustrated IO module 120, sometimes referred to as a Southbridge or South Complex of a chipset, functions as a host controller and communicates with the network controller 128, which could provide off-platform communication functionality for a wide variety of purposes such as, for example, cellular telephone (e.g., Wideband Code Division Multiple Access/W-CDMA (Universal Mobile Telecommunications System/UMTS), CDMA2000 (IS-856/IS-2000), etc.), WiFi (Wireless Fidelity, e.g., Institute of Electrical and Electronics Engineers/IEEE 802.11-2007, Wireless Local Area Network/LAN Medium Access Control (MAC) and Physical Layer (PHY) Specifications), 4G LTE (Fourth Generation Long Term Evolution), Bluetooth, WiMax (e.g., IEEE 802.16-2004, LAN/MAN Broadband Wireless LANS), Global Positioning System (GPS), spread spectrum (e.g., 900 MHz), NFC (Near Field Communication, ECMA-340, ISO/IEC 18092), and other radio frequency (RF) purposes. Other standards and/or technologies may also be implemented in the network controller 128.

The network controller 128 may therefore exchange data (e.g., ID information, security information, sensor data, pattern data, historical data, standard data, etc.). The IO module 120 may also include one or more hardware circuit blocks (e.g., smart amplifiers, analog to digital conversion, integrated sensor hub) to support such wireless and other signal processing functionality.

Although the processor 112 and IO module 120 are illustrated as separate blocks, the processor 112 and IO module 120 may be implemented as a system on chip (SoC) on the same semiconductor die. The system memory 118 may include, for example, double data rate (DDR) synchronous dynamic random access memory (SDRAM, e.g., DDR3 SDRAM JEDEC Standard JESD79-3C, April 2008) modules. The modules of the system memory 118 may be incorporated into a single inline memory module (SIMM), dual inline memory module (DIMM), small outline DIMM (SODIMM), and so forth.

The illustrated processor 112 includes logic 130 (e.g., logic instructions, configurable logic, fixed-functionality hardware logic, etc., or any combination thereof) that may implement one or more components of the system 10 (FIG. 1), one or more blocks of the methods 70, 80, 86 (FIGS. 2-4), and/or one or more flows of the system 10 and/or the methods 70, 80, 86 (FIGS. 1-4), discussed above. Thus, the logic 130 may generate sensor data, mediate pairing, and/or process sensor data. Although the illustrated logic 130 is shown as being implemented on the processor 112, one or more aspects of the logic 130 may be implemented elsewhere such as at a mobile computing platform external to the computing system 110 depending on the circumstances.

The system 110 may, therefore, identify one or more proximately located sensors, proxies, and/or repositories to allow pairing among the sensors, proxies, and/or repositories. In addition, the system 110 may allow for self-assembly, assignment of a name to a cluster, and generation of a key for a cluster. In one example, a user may bring sensors together, affix them to a part of a deployment environment (e.g., lug nuts of a vehicle, etc.) and connect them to an instrumentation system (e.g., vehicle infotainment system, etc.), wherein the sensors become lug nut sensors via their behavioral attributes. A cluster scan may discover one or more sensor clusters and a request to connect to the cluster (e.g., including a request for a security key) may be issued, whether directly from a repository such as the instrumentation system or a proxy such as a MID. When a key is provided, pairing may be complete and sensor data shared.

Accordingly, adaptable sensors that detect one or more characteristics (e.g., temperature, pressure, vibration, etc.) may be brought together to establish a logical relationship (e.g., general-purpose sensor relationship) and may be attached to various parts of an instrument. A user may launch a smart-phone application that connects to the sensor by NFC via contact with one of the sensors. The user may then connect the sensors with, e.g., a vehicle infotainment system when the user sits in the vehicle. The user may also assign a label (e.g., “front left wheel”) to the sensors. The user may iteratively repeat the process for other clusters and/or may only wish to have data from one particular cluster (e.g., a particular wheel involved in a recent road event).

When the user begins to operate the vehicle, the sensors capture data regarding vibration, temperature, speed, etc., and may not know or care they have become wheel sensors. In addition, the instrumentation system of the vehicle may collect the data that it knows is being sourced from the sensors providing, over time, a predictable signature. If the wheel later wobbles, the sensors detect the difference in vibration and the instrumentation system determines that it is different than historical vibration. The instrumentation system may then alter the use of the part by providing visual data regarding the observed anomaly. Also, the vehicle may be serviced, and/or the user interface may provide greater clarity to observations, alerts, and/or thresholds.

### ADDITIONAL NOTES AND EXAMPLES

Example 1 may include a computing system to establish a detection pattern comprising a universal sensor including a negotiator to cooperatively assemble the universal sensor with one or more other universal sensors into a general-purpose sensor cluster deployable in a dynamically configurable arrangement, a detector to capture data corresponding to one or more characteristics in a deployment environment encountered by the universal sensor, and a distributer to provide the data corresponding to at least one of the characteristics in the deployment environment encountered by the universal sensor, and a repository including an analyzer to establish a baseline detection pattern for the general-purpose sensor cluster based on data provided by each universal sensor of the general-purpose sensor cluster and detect a change in the baseline detection pattern to address an anomalous condition.

Example 2 may include the computing system of Example 1, further including a proxy comprising a coupler to one or more of pair two or more universal sensors to mediate cooperative assembly of the two or more universal sensors into the general-purpose sensor cluster or pair the repository with the general-purpose sensor cluster to establish the baseline detection pattern and detect the change in the baseline detection pattern.

Example 3 may include the computing system of any one of Example 1 to Example 2, further including a probe to one or more of identify a universal sensor or identify the general-purpose sensor cluster, wherein the probe is to include wireless communication functionality.

Example 4 may include a universal sensor to generate data in a sensor cluster comprising a negotiator to cooperatively assemble the universal sensor with one or more other universal sensors into a general-purpose sensor cluster deployable in a dynamically configurable arrangement, a detector to capture data corresponding to one or more characteristics in a deployment environment encountered by the universal sensor, and a distributer to provide the data corresponding to at least one of the characteristics in the deployment environment encountered by the universal sensor.

Example 5 may include the universal sensor of Example 4, further including one or more of a probe to identify at least one of the other universal sensors proximately located to the universal sensor or a sensor interface to pair the universal sensor with at least one of the other universal sensors to allow cooperative assembly into the general-purpose sensor cluster.

Example 6 may include the universal sensor of any one of Example 4 to Example 5, further including a repository interface to pair the universal sensor with a repository that is to establish a baseline detection pattern for the general-purpose sensor cluster based on the data and to detect a change in the baseline detection pattern.

Example 7 may include the universal sensor of any one of Example 4 to Example 6, further including a proxy interface to pair the universal sensor with a proxy that is to one or more of mediate cooperative assembly of the universal sensor with at least one of the other universal sensors into the general-purpose sensor cluster or mediate pairing of the general-purpose sensor cluster with a repository.

Example 8 may include the universal sensor of any one of Example 4 to Example 7, further including an identification determiner to one or more of determine one or more of a sensor identification corresponding to the universal sensor or a cluster identification corresponding to the general-purpose sensor cluster or provide one or more of the sensor identification or the cluster identification to one or more of a repository, a proxy, or a universal sensor.

Example 9 may include the universal sensor of any one of Example 4 to Example 8, further including a security message determiner to one or more of determine a security key corresponding to one or more of the universal sensor or the general-purpose sensor cluster or provide the security key to one or more of a repository, a proxy, or a universal sensor.

Example 10 may include the universal sensor of any one of Example 4 to Example 9, wherein the universal sensor is to include a multi-functional Internet of Things (IoT) sensor to capture data corresponding to two or more characteristics in the deployment environment including pressure, temperature, vibration, acceleration, velocity, rotation, flow, or analyte exposure, and wherein the distributer is to provide the data corresponding to the two of more characteristics.

Example 11 may include a repository to process data from a sensor cluster comprising a collector to collect data provided by each universal sensor of a general-purpose sensor cluster deployable in a dynamically configurable arrangement and an analyzer to establish a baseline detection pattern for the general-purpose sensor cluster based on the data and detect a change in the baseline detection pattern to address an anomalous condition.

Example 12 may include the repository of Example 11, further including one or more of a probe to identify the general-purpose sensor cluster, a sensor interface to pair the repository with one or more universal sensors of the general-purpose sensor cluster, or a proxy interface to pair the repository with a proxy that is to mediate pairing of the repository with the general-purpose sensor cluster.

Example 13 may include the repository of any one of Example 11 to Example 12, further including an identification determiner to determine one or more of a sensor identification corresponding to a universal sensor or a cluster identification corresponding to the general-purpose sensor cluster.

Example 14 may include the repository of any one of Example 11 to Example 13, further including a security message determiner to determine a security key corresponding to one or more of a universal sensor or the general-purpose sensor cluster.

Example 15 may include the repository of any one of Example 11 to Example 14, further including one or more of a classification determiner to determine a label indicating a specific-purpose relationship for the general-purpose sensor cluster, wherein the general-purpose sensor cluster is to operate irrespective of knowledge of the specific-purpose relationship or a tolerance determiner to determine one or more of a tolerance limit corresponding to the change in the baseline detection pattern or when the tolerance limit is met.

Example 16 may include the repository of any one of Example 11 to Example 15, further including a user interface to one or more of select the label based on user input or select the tolerance limit based on the user input.

Example 17 may include the repository of any one of Example 11 to Example 16, further including a self-learner to one or more of select the label based on data corresponding to a characteristic in a deployment environment to be included in the baseline detection pattern or select the tolerance limit based on the data corresponding to the characteristic in the deployment environment to be included in the baseline detection pattern.

Example 18 may include the repository of any one of Example 11 to Example 17, further including a responder to one or more of determine a response when the tolerance limit is met or initiate the response to prevent a failure.

Example 19 may include the repository of any one of Example 11 to Example 18, wherein the baseline detection pattern is to be based on data from a first universal sensor corresponding to a first characteristic in a deployment environment encountered by the first universal sensor of the general-purpose sensor cluster and data from a second universal sensor corresponding to a second characteristic in the deployment environment encountered by the second universal sensor of the general-purpose sensor cluster.

Example 20 may include the repository of any one of Example 11 to Example 19, wherein the repository is to include one or more of an endpoint device, a gateway device, a cloud-computing device, or a server device.

Example 21 may include a proxy to mediate pairing involving a sensor cluster comprising a probe to one or more of identify two or more universal sensors proximately located to the proxy or identify a general-purpose sensor cluster deployable in a dynamically configurable arrangement proximately located to the proxy, and a coupler to one or more of pair at least two of the universal sensors to mediate cooperative assembly of the at least two universal sensors into the general-purpose sensor cluster or pair a repository with the general-purpose sensor cluster to establish a baseline detection pattern for the general-purpose sensor cluster based on data provided by each universal sensor of the general-purpose sensor cluster and to detect a change in the baseline detection pattern to address an anomalous condition.

Example 22 may include the proxy of Example 21, further including an identification determiner to one or more of determine one or more of a sensor identification corresponding to a universal sensor or a cluster identification corresponding to the general-purpose sensor cluster or provide one or more of the sensor identification or the cluster identification to one or more of a universal sensor or the repository.

Example 23 may include the proxy of any one of Example 21 to Example 22, further including a security message determiner to one or more of determine a security key corresponding to one or more of a universal sensor or the general-purpose sensor cluster or provide the security key to one or more of a universal sensor or the repository.

Example 24 may include a proxy of any one of Example 21 to Example 23, wherein the proxy is to include a mobile computing platform.

Example 25 may include least one computer readable storage medium comprising a set of instructions, which when executed by a universal sensor, cause the universal sensor to cooperatively assemble the universal sensor with one or more other universal sensors into a general-purpose sensor cluster deployable in a dynamically configurable arrangement, capture data corresponding to one or more characteristics in a deployment environment encountered by the universal sensor, and provide the data corresponding to at least one of the characteristics in the deployment environment encountered by the universal sensor.

Example 26 may include the at least one computer readable storage medium of Example 25, wherein the instructions, when executed, cause the universal sensor to one or more of identify at least one of the other universal sensors proximately located to the universal sensor or pair the universal sensor with at least one of the other universal sensors to allow cooperative assembly into the general-purpose sensor cluster.

Example 27 may include the at least one computer readable storage medium of any one of Example 25 to Example 26, wherein the instructions, when executed, cause the universal sensor to pair the universal sensor with a repository that is to establish a baseline detection pattern for the general-purpose sensor cluster based on the data and to detect a change in the baseline detection pattern.

Example 28 may include the at least one computer readable storage medium of any one of Example 25 to Example 27, wherein the instructions, when executed, cause the universal sensor to pair the universal sensor with a proxy that is to one or more of mediate cooperative assembly of the universal sensor with at least one of the other universal sensors into the general-purpose sensor cluster or mediate pairing of the general-purpose sensor cluster with a repository.

Example 29 may include the at least one computer readable storage medium of any one of Example 25 to Example 28, wherein the instructions, when executed, cause the universal sensor to one or more of determine one or more of a sensor identification corresponding to the universal sensor or a cluster identification corresponding to the general-purpose sensor cluster or provide one or more of the sensor identification or the cluster identification to one or more of a repository, a proxy, or a universal sensor.

Example 30 may include the at least one computer readable storage medium of any one of Example 25 to Example 29, wherein the instructions, when executed, cause the universal sensor to one or more of determine a security key corresponding to one or more of the universal sensor or the general-purpose sensor cluster or provide the security key to one or more of a repository, a proxy, or a universal sensor.

Example 31 may include the at least one computer readable storage medium of any one of Example 25 to Example 30, wherein the universal sensor is to include a multi-functional Internet of Things (IoT) sensor to capture data corresponding to two or more characteristics in the deployment environment including pressure, temperature, vibration, acceleration, velocity, rotation, flow, or analyte exposure.

Example 32 may include least one computer readable storage medium comprising a set of instructions, which when executed by a repository, cause the repository to collect data provided by each universal sensor of a general-purpose sensor cluster deployable in a dynamically configurable arrangement, establish a baseline detection pattern for the general-purpose sensor cluster based on the data, and detect a change in the baseline detection pattern to address an anomalous condition.

Example 33 may include the at least one computer readable storage medium of Example 32, wherein the instructions, when executed, cause the repository to one or more of identify the general-purpose sensor cluster, pair the repository with one or more universal sensors of the general-purpose sensor cluster, or pair the repository with a proxy that is to mediate pairing of the repository with the general-purpose sensor cluster.

Example 34 may include the at least one computer readable storage medium of any one of Example 32 to Example 33, wherein the instructions, when executed, cause the repository to determine one or more of a sensor identification corresponding to a universal sensor or a cluster identification corresponding to the general-purpose sensor cluster.

Example 35 may include the at least one computer readable storage medium of any one of Example 32 to Example 34, wherein the instructions, when executed, cause the repository to determine a security key corresponding to one or more of a universal sensor or the general-purpose sensor cluster.

Example 36 may include the at least one computer readable storage medium of any one of Example 32 to Example 35, wherein the instructions, when executed, cause the repository to one or more of determine a label indicating a specific-purpose relationship for the general-purpose sensor cluster, wherein the general-purpose sensor cluster is to operate irrespective of knowledge of the specific-purpose relationship or determine one or more of a tolerance limit corresponding to the change in the baseline detection pattern or when the tolerance limit is met.

Example 37 may include the at least one computer readable storage medium of any one of Example 32 to Example 36, wherein the instructions, when executed, cause the repository to one or more of select the label based on user input or select the tolerance limit based on the user input.

Example 38 may include the at least one computer readable storage medium of any one of Example 32 to Example 37, wherein the instructions, when executed, cause the repository to one or more of select the label based on data corresponding to a characteristic in a deployment environment to be included in the baseline detection pattern or select the tolerance limit based on the data corresponding to the characteristic in the deployment environment to be included in the baseline detection pattern.

Example 39 may include the at least one computer readable storage medium of any one of Example 32 to Example 38, wherein the instructions, when executed, cause the repository to one or more of determine a response when the tolerance limit is met or initiate the response to prevent a failure.

Example 40 may include the at least one computer readable storage medium of any one of Example 32 to Example 39, wherein the baseline detection pattern is to be based on data from a first universal sensor corresponding to a first characteristic in a deployment environment encountered by the first universal sensor of the general-purpose sensor cluster and data from a second universal sensor corresponding to a second characteristic in the deployment environment encountered by the second universal sensor of the general-purpose sensor cluster.

Example 41 may include the at least one computer readable storage medium of any one of Example 32 to Example 40, wherein the repository is to include one or more of an endpoint device, a gateway device, a cloud-computing device, or a server device.

Example 42 may include least one computer readable storage medium comprising a set of instructions, which when executed by a proxy, cause the proxy to identify one or more of two or more universal sensors proximately located to the proxy or a general-purpose sensor cluster deployable in a dynamically configurable arrangement proximately located to the proxy, and pair one or more of at least two of the universal sensors to mediate cooperative assembly of the at least two universal sensors into the general-purpose sensor cluster or a repository with the general-purpose sensor cluster to establish a baseline detection pattern for the general-purpose sensor cluster based on data provided by each universal sensor of the general-purpose sensor cluster and to detect a change in the baseline detection pattern to address an anomalous condition.

Example 43 may include the at least one computer readable storage medium of Example 42, wherein the instructions, when executed, cause the proxy to one or more of determine one or more of a sensor identification corresponding to a universal sensor or a cluster identification corresponding to the general-purpose sensor cluster or provide one or more of the sensor identification or the cluster identification to one or more of a universal sensor or the repository.

Example 44 may include the at least one computer readable storage medium of any one of Example 42 to Example 43, wherein the instructions, when executed, cause the proxy to one or more of determine a security key corresponding to one or more of a universal sensor or the general-purpose sensor cluster or provide the security key to one or more of a universal sensor or the repository.

Example 45 may include the at least one computer readable storage medium of any one of Example 42 to Example 44, wherein the proxy is to include a mobile computing platform.

Example 46 may include a method to generate data in a sensor cluster comprising cooperatively assembling a universal sensor with one or more other universal sensors into a general-purpose sensor cluster deployable in a dynamically configurable arrangement, capturing data corresponding to one or more characteristics in a deployment environment encountered by the universal sensor, and providing the data corresponding to at least one of the characteristics in the deployment environment encountered by the universal sensor.

Example 47 may include the method of Example 46, further including one or more of identifying at least one of the other universal sensors proximately located to the universal sensor or pairing the universal sensor with at least one of the other universal sensors to allow cooperative assembly into the general-purpose sensor cluster.

Example 48 may include the method of any one of Example 46 to Example 47, further including pairing the universal sensor with a repository that is to establish a baseline detection pattern for the general-purpose sensor cluster based on the data and to detect a change in the baseline detection pattern.

Example 49 may include the method of any one of Example 46 to Example 48, further including pairing the universal sensor with a proxy that is to one or more of mediate cooperative assembly of the universal sensor with at least one of the other universal sensors into the general-purpose sensor cluster or mediate pairing of the general-purpose sensor cluster with a repository.

Example 50 may include the method of any one of Example 46 to Example 49, further including one or more of determining one or more of a sensor identification corresponding to the universal sensor or a cluster identification corresponding to the general-purpose sensor cluster or providing one or more of the sensor identification or the cluster identification to one or more of a repository, a proxy, or a universal sensor.

Example 51 may include the method of any one of Example 46 to Example 50, further including one or more of determining a security key corresponding to one or more of the universal sensor or the general-purpose sensor cluster or providing the security key to one or more of a repository, a proxy, or a universal sensor.

Example 52 may include the method of any one of Example 46 to Example 51, wherein the universal sensor includes a multi-functional Internet of Things (IoT) sensor to capture data corresponding to two or more characteristics in the deployment environment including pressure, temperature, vibration, acceleration, velocity, rotation, flow, or analyte exposure.

Example 53 may include a method to process data from a sensor cluster comprising collecting data provided by each universal sensor of a general-purpose sensor cluster deployable in a dynamically configurable arrangement, and establishing a baseline detection pattern for the general-purpose sensor cluster based on the data, and detecting a change in the baseline detection pattern to address an anomalous condition.

Example 54 may include the method of Example 53, further including one or more of identifying the general-purpose sensor cluster, pairing the repository with one or more universal sensors of the general-purpose sensor cluster, or pairing the repository with a proxy that is to mediate pairing of the repository with the general-purpose sensor cluster.

Example 55 may include the method of any one of Example 53 to Example 54, further including determining one or more of a sensor identification corresponding to a universal sensor or a cluster identification corresponding to the general-purpose sensor cluster.

Example 56 may include the method of any one of Example 53 to Example 55, further including determining a security key corresponding to one or more of a universal sensor or the general-purpose sensor cluster.

Example 57 may include the method of any one of Example 53 to Example 56, further including one or more of determining a label indicating a specific-purpose relationship for the general-purpose sensor cluster, wherein the general-purpose sensor cluster is to operate irrespective of knowledge of the specific-purpose relationship, or determining one or more of a tolerance limit corresponding to the change in the baseline detection pattern or when the tolerance limit is met.

Example 58 may include the method of any one of Example 53 to Example 57, further including one or more of selecting the label based on user input or selecting the tolerance limit based on the user input.

Example 59 may include the method of any one of Example 53 to Example 58, further including one or more of selecting the label based on data corresponding to a characteristic in a deployment environment to be included in the baseline detection pattern or selecting the tolerance limit based on the data corresponding to the characteristic in the deployment environment to be included in the baseline detection pattern.

Example 60 may include the method of any one of Example 53 to Example 59, further including one or more of determining a response when the tolerance limit is met or initiating the response to prevent a failure.

Example 61 may include the method of any one of Example 53 to Example 60, wherein the baseline detection pattern is to be based on data from a first universal sensor corresponding to a first characteristic in a deployment environment encountered by the first universal sensor of the general-purpose sensor cluster and data from a second universal sensor corresponding to a second characteristic in the deployment environment encountered by the second universal sensor of the general-purpose sensor cluster.

Example 62 may include the method of any one of Example 53 to Example 61, wherein the repository includes one or more of an endpoint device, a gateway device, a cloud-computing device, or a server device.

Example 63 may include a method to process data from a sensor cluster comprising identifying one or more of two or more universal sensors proximately located to the proxy or a general-purpose sensor cluster deployable in a dynamically configurable arrangement proximately located to the proxy, and pairing one or more of at least two of the universal sensors to mediate cooperative assembly of the at least two universal sensors into the general-purpose sensor cluster or a repository with the general-purpose sensor cluster to establish a baseline detection pattern for the general-purpose sensor cluster based on data provided by each universal sensor of the general-purpose sensor cluster and to detect a change in the baseline detection pattern to address an anomalous condition.

Example 64 may include the method of Example 63, further including one or more of determining one or more of a sensor identification corresponding to a universal sensor or a cluster identification corresponding to the general-purpose sensor cluster or providing one or more of the sensor identification or the cluster identification to one or more of a universal sensor or the repository.

Example 65 may include the method of any one of Example 63 to Example 64, further including one or more of determining a security key corresponding to one or more of a universal sensor or the general-purpose sensor cluster or providing the security key to one or more of a universal sensor or the repository.

Example 66 may include the method of any one of Example 63 to Example 65, wherein the proxy is to include a mobile computing platform.

Example 67 may include a universal sensor to generate data in a sensor cluster comprising means for performing the method of any one of Example 46 to Example 52.

Example 68 may include a repository to process data from a sensor cluster comprising means for performing the method of any one of Example 53 to Example 62.

Example 69 may include a proxy to provide mediate pairing involving a sensor cluster comprising means for performing the method of any one of Example 63 to Example 66.

Thus, embodiments may include systems, apparatuses, and/or methods to establish ad-hoc pairing between two or more sensors (e.g. IoT sensors) to form a sensor cluster. In addition, embodiments may include systems, apparatuses, and/or methods to establish a relationship between a sensor cluster and a computing system. For example, a relatively simple WiFi setup may broadcast cluster information to a central unit such as a relatively low-power processor unit that identifies various sensors, classifies the sensors together, and receives information from the sensors. The central unit may, for example, scan for sensors in its range (e.g., WiFi, NFC, RF, etc.) and classify a group of sensors related to the equipment (e.g., identifying a unique ID) via self-learning and/or user input.

Embodiments may include systems, apparatuses, and/or methods to provide pre-defined tolerance information via user input and/or self-learning, wherein the central unit may learn normal and/or abnormal operating parameters. In addition, the central unit may share the information (e.g., from neural networks) to another computer system for further analysis and/or to develop industry standards. The collected data and/or results from local analysis may be provided to a cloud computing system to provide information on a relatively larger scale. The information may be aggregated from discrete computing systems and leveraged to refine local learning processes.

Embodiments may also include systems, apparatuses, and/or methods to provide security to minimize a compromise. For example, keys may be exchanged with a smart phone acting as a proxy to allow pairing (e.g., cluster formation), data exchange, and/or network configuration. Encryption of data using, for example, public/private keys generated at random when a cluster is created may minimize malicious interception of communications and/or access to a central unit. In one example, a compromised sensor may be deleted from a cluster and/or a user may be notified when data is corrupt.

Embodiments may also include systems, apparatuses, and/or methods to learn when sensors are producing data indicative of a failure. Generally, a central unit may evaluate any changes across sensors as well as uniform changes across sensors. In one example, the central unit may utilize machine learning to identify anomalies in behavior when compared with other similar systems. For example, vibration of one wheel may be compared with vibration form other wheels in the same vehicle to minimize training and/or pre-configuration. The information may be processed and displayed in any format, such as graphical format, command line format, audio format, and so on.

Accordingly, individual sensors may be paired (e.g., via direct contact with each other, via direct contact with a proxy, etc.) to form a sensor cluster, which have shared security keys and/or individual keys. In one example to connect the sensor cluster to a computer system (e.g., vehicle computer system, a separate computer component such as an IoT gateway, etc.), an NFC antenna system may be hardwired to a computer system and placed near, for example, a wheel assembly to be identified by the sensor cluster. Hard-wired NFC extenders may be provided throughout a vehicle, and a key exchange may occur when the sensor cluster is in proximity to the NFC antenna.

In another example to connect the sensor cluster to a computer system, a smart phone may be used as a proxy to accept the key and pass it to the vehicle computer system. For example, sensor cluster may make packets of data available describing that it is a sensor cluster when a sensor cluster NFC and a smartphone NFC are in proximity to each other. An application on the smartphone and/or the vehicle computer system may then request ID data from the sensor cluster. In one example, a master sensor may transmit a cluster ID to the smart phone, which determines whether the cluster ID is new or existing and requests a key if the cluster ID is new. The key is transmitted to the smart phone via a read operation initiated by the smart phone. Moreover, network connection data (e.g., WiFi, etc.) may be transmitted as a write operation. For example, the master sensor may read the network connection data and configure it's own network connection.

The smart phone may now have the cluster ID, the key, and/or any other metadata. The smart phone may also implement a similar process in reverse to write the key and/or other data such as the cluster ID to the vehicle computer system. In addition, the sensor cluster may have information to establish a wireless connection (e.g., WiFi, NFC, etc.). In one example, pairing may be complete when the cluster ID has been successfully exchanged, the key has been successfully exchanged, and network configuration data has been successfully exchanged.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” or “at least one of” may mean any combination of the listed terms. For example, the phrases “one or more of A, B or C” may mean A; B; C; A and B; A and C; B and C; or A, B and C. In addition, a list of items joined by the term “and so forth” or “etc.” may mean any combination of the listed terms as well any combination with other terms.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system to establish a detection pattern comprising:
a universal sensor including:
a negotiator to cooperatively assemble the universal sensor with one or more other universal sensors into a general-purpose sensor cluster deployable in a dynamically configurable arrangement;
a detector to capture data corresponding to one or more characteristics in a deployment environment encountered by the universal sensor; and
a distributer to provide the data corresponding to at least one of the characteristics in the deployment environment encountered by the universal sensor; and
a repository including an analyzer to:
establish a baseline detection pattern for the general-purpose sensor cluster based on data provided by each universal sensor of the general-purpose sensor cluster; and
detect a change in the baseline detection pattern to address an anomalous condition.

2. The computing system of claim 1, further including a proxy comprising a coupler to one or more of:
pair two or more universal sensors to mediate cooperative assembly of the two or more universal sensors into the general-purpose sensor cluster; or
pair the repository with the general-purpose sensor cluster to establish the baseline detection pattern and detect the change in the baseline detection pattern.

3. The computing system of claim 1, further including a probe to one or more of:
identify a universal sensor; or
identify the general-purpose sensor cluster, wherein the probe is to include wireless communication functionality.

4. A universal sensor to generate data in a sensor cluster comprising:
a negotiator to cooperatively assemble the universal sensor with one or more other universal sensors into a general-purpose sensor cluster deployable in a dynamically configurable arrangement;
a detector to capture data corresponding to one or more characteristics in a deployment environment encountered by the universal sensor; and
a distributer to provide the data corresponding to at least one of the characteristics in the deployment environment encountered by the universal sensor.

5. The universal sensor of claim 4, further including one or more of:
a probe to identify at least one of the other universal sensors proximately located to the universal sensor; or
a sensor interface to pair the universal sensor with at least one of the other universal sensors to allow cooperative assembly into the general-purpose sensor cluster.

6. The universal sensor of claim 4, further including a repository interface to pair the universal sensor with a repository that is to establish a baseline detection pattern for the general-purpose sensor cluster based on the data and to detect a change in the baseline detection pattern.

7. The universal sensor of claim 4, further including a proxy interface to pair the universal sensor with a proxy that is to one or more of:
mediate cooperative assembly of the universal sensor with at least one of the other universal sensors into the general-purpose sensor cluster; or
mediate pairing of the general-purpose sensor cluster with a repository.

8. The universal sensor of claim 4, further including an identification determiner to one or more of:
determine one or more of a sensor identification corresponding to the universal sensor or a cluster identification corresponding to the general-purpose sensor cluster; or
provide one or more of the sensor identification or the cluster identification to one or more of a repository, a proxy, or a universal sensor.

9. The universal sensor of claim 4, further including a security message determiner to one or more of:
determine a security key corresponding to one or more of the universal sensor or the general-purpose sensor cluster; or
provide the security key to one or more of a repository, a proxy, or a universal sensor.

10. The universal sensor of claim 4, wherein the universal sensor is to include a multi-functional Internet of Things (IoT) sensor to capture data corresponding to two or more characteristics in the deployment environment including pressure, temperature, vibration, acceleration, velocity, rotation, flow, or analyte exposure, and wherein the distributer is to provide the data corresponding to the two of more characteristics.

11. A repository to process data from a sensor cluster comprising:
a collector to collect data provided by each universal sensor of a general-purpose sensor cluster deployable in a dynamically configurable arrangement; and
an analyzer to:
establish a baseline detection pattern for the general-purpose sensor cluster based on the data; and
detect a change in the baseline detection pattern to address an anomalous condition.

12. The repository of claim 11, further including one or more of:
a probe to identify the general-purpose sensor cluster;
a sensor interface to pair the repository with one or more universal sensors of the general-purpose sensor cluster; or
a proxy interface to pair the repository with a proxy that is to mediate pairing of the repository with the general-purpose sensor cluster.

13. The repository of claim 11, further including an identification determiner to determine one or more of a sensor identification corresponding to a universal sensor or a cluster identification corresponding to the general-purpose sensor cluster.

14. The repository of claim 11, further including a security message determiner to determine a security key corresponding to one or more of a universal sensor or the general-purpose sensor cluster.

15. The repository of claim 11, further including one or more of:
a classification determiner to determine a label indicating a specific-purpose relationship for the general-purpose sensor cluster, wherein the general-purpose sensor cluster is to operate irrespective of knowledge of the specific-purpose relationship; or
a tolerance determiner to determine one or more of a tolerance limit corresponding to the change in the baseline detection pattern or when the tolerance limit is met.

16. The repository of claim 15, further including a user interface to one or more of:
select the label based on user input; or
select the tolerance limit based on the user input.

17. The repository of claim 15, further including a self-learner to one or more of:
select the label based on data corresponding to a characteristic in a deployment environment to be included in the baseline detection pattern; or
select the tolerance limit based on the data corresponding to the characteristic in the deployment environment to be included in the baseline detection pattern.

18. The repository of claim 15, further including a responder to one or more of:
determine a response when the tolerance limit is met; or
initiate the response to prevent a failure.

19. The repository of claim 11, wherein the baseline detection pattern is to be based on data from a first universal sensor corresponding to a first characteristic in a deployment environment encountered by the first universal sensor of the general-purpose sensor cluster and data from a second universal sensor corresponding to a second characteristic in the deployment environment encountered by the second universal sensor of the general-purpose sensor cluster.

20. The repository of claim 11, wherein the repository is to include one or more of an endpoint device, a gateway device, a cloud-computing device, or a server device.

21. A proxy to mediate pairing involving a sensor cluster comprising:
a probe to one or more of:
identify two or more universal sensors proximately located to the proxy;
or
identify a general-purpose sensor cluster deployable in a dynamically configurable arrangement proximately located to the proxy; and
a coupler to one or more of:
pair at least two of the universal sensors to mediate cooperative assembly of the at least two universal sensors into the general-purpose sensor cluster; or
pair a repository with the general-purpose sensor cluster to establish a baseline detection pattern for the general-purpose sensor cluster based on data provided by each universal sensor of the general-purpose sensor cluster and to detect a change in the baseline detection pattern to address an anomalous condition.

22. The proxy of claim 21, further including an identification determiner to one or more of:
determine one or more of a sensor identification corresponding to a universal sensor or a cluster identification corresponding to the general-purpose sensor cluster; or
provide one or more of the sensor identification or the cluster identification to one or more of a universal sensor or the repository.

23. The proxy of claim 21, further including a security message determiner to one or more of:
determine a security key corresponding to one or more of a universal sensor or the general-purpose sensor cluster; or
provide the security key to one or more of a universal sensor or the repository.

24. The proxy of claim 21, wherein the proxy is to include a mobile computing platform.
